(19) United States
(12) Patent Application Publication
(10) Pub. No.: US 2009/0182643 A1
(43) Pub. Date: Jul. 16, 2009

(54) System And Method For Tracking A User's Navigation On A Website And Enabling A Customer Service Representative To Replicate The User's State

(75) Inventors: Paul D. Holstein, Fort Lauderdale, FL (US); Nicolas Dubus, Fort Lauderdale, FL (US); Daniel Shields, Fort Lauderdale, FL (US)

Correspondence Address: CARLTON FIELDS, P.A.;Attn: IP Dept., P.O. BOX 3239, TAMPA, FL, 33601-3239, US

(73) Assignee: CableOrganizer.com, Inc., Fort Lauderdale, FL (US)

(21) Appl. No.: 12/350,273

(22) Filed: Jan. 8, 2009

Related U.S. Application Data
(60) Provisional application No. 61/020,247, filed on Jan. 10, 2008.

(51) Int. Cl. G06Q 30/00; G06Q 10/00

(52) U.S. Cl. 705/26; 705/30

(57) ABSTRACT

A system, method and computer readable medium for tracking and replicating user navigation on a website having multiple user web pages. At least one user web page includes a session code link that displays a session code identifier to the user and causes a session code and a web page identifier to be stored in a database. A customer service representative (CSR) web page is then adapted to display the stored session code identifier and provide a replicate state link that will cause the server to display the user web page identified by the user web page identifier to the CSR. This allows the CSR to see the page being viewed by the user when the user requests assistance in using the website.

### BACKGROUND

The present invention relates to a system for enabling a customer service representative to assist a customer who is using a website.

Businesses are increasingly using websites to communicate with, and sell products and services to, their prospects and customers. Users, consequently, have begun to expect and demand that businesses provide feature-rich websites and ever-increasing amounts of online content. The result is that websites have become more complex, and there is a growing need for users to contact customer service representatives to assist the users in navigating and using those sites. When the user contacts the customer service representative, however, the user and the representative must spend time and effort trying to identify the exact portion of the site that is causing the difficulty and, in some cases, determining how the user arrived at that location. If the representative had an automatic method of identifying the page the user was viewing when the user made the call, the support process and customer experience would both be enhanced.

Systems and methods for tracking user navigation on a website are known in the art. However, such systems and methods typically require tracking all user actions, as opposed to focusing on the most recent page visits, and require large amounts of storage space. Some users also object to such systems because they do not wish to have their every move on a site tracked and recorded for future use by the site's owner.

Accordingly, it is an object of the present invention to provide a system and method for enabling a customer service representative to identify a user's location on a website without necessarily requiring large amounts of storage or recording every move the user makes on the site.

### SUMMARY

According to the present invention, there is provided a system for tracking and replicating user navigation on a website comprising a plurality of user web pages, a customer service representative (“CSR”) web page, a server, and a database wherein the server is programmed to serve user web pages and at least one CSR web page. The server is further programmed, upon a user requesting one of the user web pages, to determine if a session code has been generated for that user, and if a session code has not been generated for the user, the server is programmed to generate one. At least one of the user web pages comprises a session code link adapted such that, upon the user selecting the session code link, the user web page displays a session code identifier to the user, and the server stores the session code and a user web page identifier in the database. The server is further programmed, upon a CSR requesting the CSR web page; to read the session code from the database, adapt the CSR web page to display the session code identifier and a replicate state link to the CSR, and to serve the adapted CSR web page to the CSR. The replicate state link on the CSR web page is adapted to cause the server to serve the user web page identified by the user web page identifier to the CSR when the CSR selects the link.

There is also provided a method of enabling a CSR to assist users in navigating a website comprising the steps of providing a database, providing a website comprising a plurality of user web pages, and providing a CSR web page. Upon a user requesting one of the user web pages, it is determined if a session code has been generated for the user. If a session code has not already been generated for that user, one is generated. A further step is to provide a session code link on at least one of the user web pages, such that upon the user selecting the session code link, a session code identifier is displayed to the user and the session code and a user web page identifier are stored in the database. A further step is, upon a CSR requesting the CSR web page, to adapt the CSR web page to display the session code identifier and a replicate state link to the CSR, and then serve the adapted CSR web page to the CSR. Upon the CSR selecting the replicate state link, the user web page identified by the user web page identifier is served to the CSR.

There is also provided a computer-usable medium having computer readable instructions stored thereon for execution by a processor to perform a method of enabling a CSR to better assist a website user.

### BRIEF DESCRIPTION OF THE DRAWINGS

Other features in the invention will become apparent from the attached drawings, which illustrate certain preferred embodiments of the system, method, and storage medium of this invention, wherein

FIG. 1 is a schematic illustrating the medium of the present invention and the operation of one embodiment of the system and method of the present invention;

FIG. 2 is a flowchart illustrating the operation of one embodiment of the system and method of the present invention;

FIG. 3 is a flowchart illustrating the operation of one embodiment of the system and method of the present invention comprising a shopping cart;

FIG. 4 is a flowchart illustrating the operation of one embodiment of the system and method of the present invention comprising logging a purchase transaction;

FIG. 5 is a flowchart illustrating the operation of one embodiment of the system and method of the present invention comprising a page counter;

FIG. 6 is a flowchart illustrating the operation of one embodiment of the system and method of the present invention comprising storing a referring web page URL upon completion of a purchase transaction; and

FIG. 7 is a flowchart illustrating the operation of one embodiment of the system and method of the present invention comprising storing user web page identifiers in a database.

### DETAILED DESCRIPTION

While the following describes preferred embodiments of the system, method, and medium of this invention, it is to be understood that this description is to be considered only as illustrative of the principles of the invention and is not to be limitative thereof, as numerous other variations, all within the scope of the invention, will readily occur to others.

The term “adapted” shall mean programmed, configured, dimensioned, oriented and arranged as appropriate.

The term “CSR” shall mean customer service representative, which may be a human being or an automated agent such as an artificial intelligence, a voice-response system, or an interactive help system.

The term “upon” shall mean substantially upon or after as appropriate, and shall not be required to mean immediately upon or within any specific time period.

The term “to serve,” when used in the context of web pages or other data to be transmitted from one computer to another, shall mean to cause data within the memory of a computing device (e.g. a general purpose computer, handheld device, or cellular smart phone) to be transmitted to one or more other computing devices across a network in such a manner as to transform the state of the memory of the receiving device such that it contains a representation of the transmitted data.

The term “to display” shall mean to transform the images shown on a computing device's display apparatus (e.g. a LCD panel connected to a general purpose computer or a touch screen on a handheld device) to convey particular information, images, or arrangements to a user operating such a device.

The term “to store” shall mean to transform the volatile memory or persistent storage of a computing device to contain a representation of a set of one or more data values, images, sounds, and/or text blocks.

The term “web page” shall mean an arranged set of instructions, images and text stored in the memory of a computing device and displayable on the display apparatus of the same computing device or a different computing device. A web page will typically comprise a set of HTML instructions, controls (e.g. ActiveX controls, Java applets, and the like), image files, script instructions, meta-tags, and text. In connection with a web page, the “to adapt” shall mean to transform the memory containing the web page such that the display will be changed when the web page is displayed.

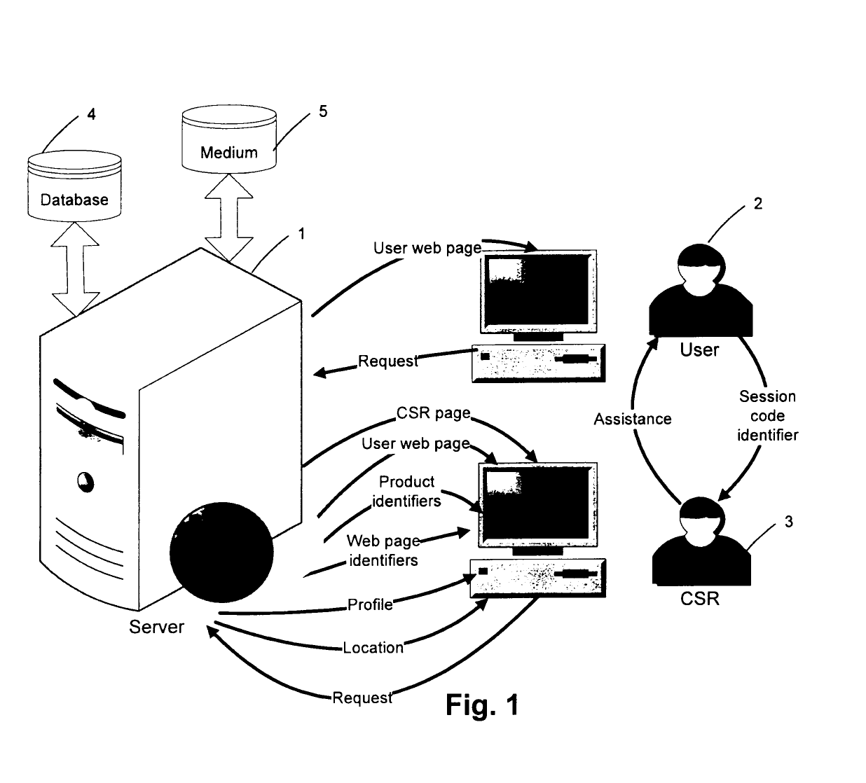

FIGS. 1-7 illustrate preferred embodiments of the system, method, and medium of this invention. FIG. 1 shows a server 1 programmed to serve a set of user web pages and at least one CSR web page. The server may be a single computer or multiple computers configured to operate together, as is well understood in the art. The server is typically connected to an open global computer information network such as the Internet, but may also be connected to a closed network in applications where the users 2 are not members of the public, but, instead, are members of a specific group. For illustration purposes only, an example of a specific group of users who could access the system of the present invention or participate in the method of the present invention, over a closed network would be a group of employees needing to access a human resources site maintained by their employer. For further illustration, an example of a group of users who could access the system of the present invention, or participate in the method of the present invention, over an open network would be potential customers of an e-commerce website designed to enable customers to purchase retail products such as www.cableorganizer.com.

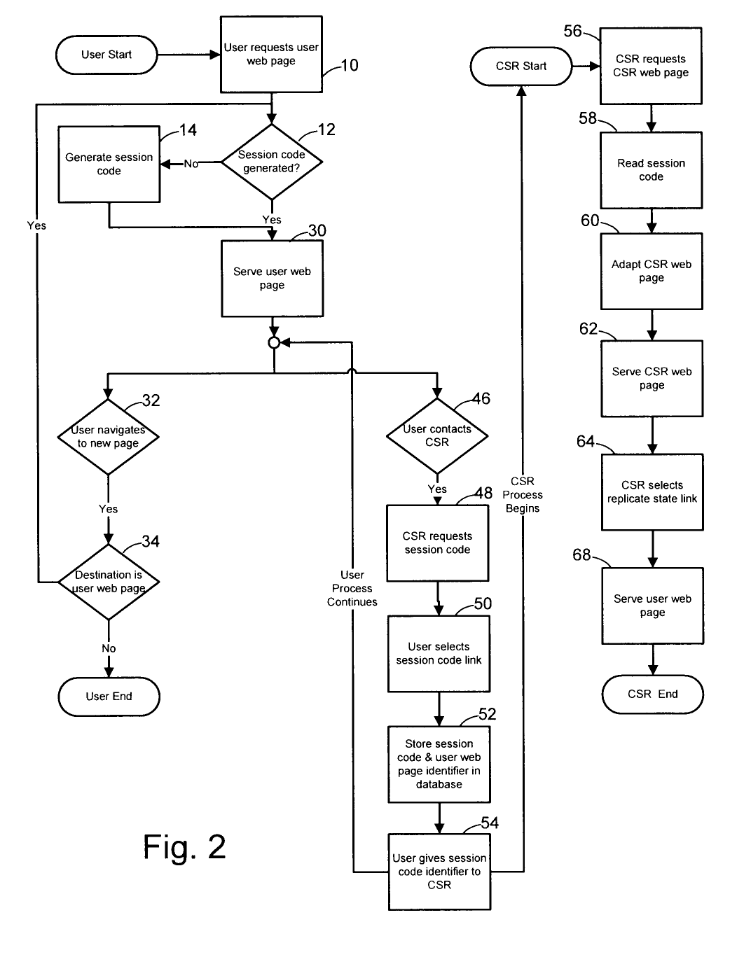

FIGS. 2-7 show flowcharts illustrating operations performed by the system of the present invention and steps performed by the method of the present invention and the method encompassed in the instructions of the medium of the present invention. While the flowcharts suggest a particular ordering of operations and steps, it will be understood by those of ordinary skill in the art, that systems comprising web pages may be inherently stateless, meaning that users 2 and CSR 3 are not restricted to a single path through the pages available to them. Accordingly, while the flowcharts illustrate a preferred ordering of the operations and steps, it is understood that neither the system nor the method of the present invention are dependent on the specific ordering indicated in the figures.

Referring to FIG. 1, the system and method of the present invention typically encompass a user 2 accessing a website by viewing user web pages. At some point in time, user 2 may require assistance from a CSR 3. CSR 3 may desire to view the user web pages recently viewed by user 2 in order to better assist user 2. Accordingly, CSR 3 may view the user web pages in the same manner as user 2. CSR 3, however, may also access a CSR web page that is not generally available to user 2. Both the user web pages and the CSR web page are served by server 1. Server 1 either includes, or is connected to medium 5, which may suitably be a hard disk, a file server, or solid-state memory, and contains instructions enabling the processor of the server to perform the method of the present invention. In a preferred embodiment of the medium of the present invention, medium 5 is a random access memory in server 1 that is accessed directly by server's 1 processor.

Server 1 is further connected to database 4 running on server 1 or, preferably, on one or more computers connected to server 1 via a network. While database 4 is preferably a software-based, relational database system such as MySQL or SQL Server, it may also be a hierarchical or flat-file system as may be convenient based on configuration of server 1 and the volume of traffic on the site hosting the user web pages. Sites with high volumes of users or support calls and sites run by businesses with advanced reporting needs will benefit from using a powerful, commercial database. Other sites may use simple database systems or files. At minimum, database 4 must be capable of persisting records of data and configured to enable server 1 to store and retrieve records according to the system and method of the present invention.

Referring to FIG. 2, the system of the present invention typically begins when user 2 requests a user web page (step 10). Requesting a user web page (step 10) may be accomplished by entering a uniform resource locator (URL) for the user web page into a web browser, or by selecting a link on an external page, email message, document, or application that is adapted to redirect the user 2 to the user web page, or by any number of other techniques that are well understood in the art. Server 1 is programmed, upon receiving a request for the user web page, to determine if a session code has been generated (step 12) for the user making the request and, if not, to generate one (step 14). As is well understood in the art, a session code is a unique value that is associated with a user or a user's visit to a website. Preferably, the session code is generated by web server software (sometimes referred to herein simply as a “web server”), such as Apache or Microsoft IIS, running on server 1 and may typically be based on the Internet protocol (IP) address assigned to the computer being used by user 2. Server 1 then serves the requested user web page (step 30) to user 2. This process is repeated as user 2 navigates among the user web pages. Preferably, however, the session code is only generated once per site visit.

At least one user web page will comprise a session code link (not shown). The term “link” means a hypertext link, a button, a hyperlinked graphic, or a similar control or device on a web page, in a document, or provided by an application, that is adapted to perform an action when a computer user interacts with it in a predefined way. Typical ways by which a user may interact with a link include clicking on it, selecting it on a touch-screen, typing a predefined set of keystrokes, or completing a mouse or touchpad gesture. While the session code link may be shown prominently on the user web page, it is preferably in an unobtrusive location that is not obvious to user 2. For example, it may be a hyperlinked graphic with a picture of a telephone operator or a hypertext link in the page footer.

Should user 2 begin to have difficulty using the site, or simply wish to contact a CSR 3 regarding the site, user 2 may do so (step 46), typically either by dialing a telephone number, or by selecting a support link that invokes an online chat session with a CSR 3. The telephone number or support link, may be displayed on or in the same user web page as the session code link, or may be shown in a popup window, tab, control, or frame accessed from the user web page. Showing the telephone number or support link on the user web page or in a popup window accessible directly from the user web page is preferable because user 2 will not have to navigate away from the user web page with which he or she is seeking assistance in order to obtain instructions for contacting CSR 3.

Upon being contacted, CSR 3 requests the session code (step 48). Preferably, CSR 3 will do so by requesting that user 2 select the session code link (step 50). In the event the session code link is not prominent on the user web page, CSR 3 may do so by instructing user 2 to click on or otherwise activate a particular element on the page, such as a picture of a telephone operator.

The session code link is adapted such that, upon being selected by user 2, the user web page performs a number of actions, the order of which is a matter of choice. One action is to display a session code identifier (not shown) to user 2, either by modifying the user web page, displaying a message window, or causing a new web page to be displayed, preferably in a pop-up window, frame, dialog or control. The session code identifier may be a numeric or textual representation of the session code itself. Preferably, however, it is shorter value, such as a word, phrase, or series of characters and numbers, that uniquely identifies the session code generated for user 2. A second action is to store the session code (step 52) and an identifier for the user web page (not shown) in database 4. Storing the session code may preferably be accomplished by storing the session code, the session code identifier, and the user web page identifier in a table in a relational database. However, it is will be understood by those of ordinary skill in the art that, if the session code identifier can be calculated from the session code, or vice versa, it is not necessary to store both values. In that event, storing the session code can be accomplished by storing only the session code identifier and the user web page identifier. The user web page identifier will preferably be the URL to the user web page, but may also be any other unique value associated with the user web page such that server 1 can determine the URL to the user web page from the user web page identifier. Once the session code identifier has been displayed to user 2, user 2 will give the session code identifier to the CSR (step 54).

Upon learning the session code identifier, CSR 3 will request a CSR web page (step 56). Preferably, CSR 3 will do so by requesting a URL that is stored as a bookmark or favorite in a web browser, by refreshing a page that is already being displayed, by entering a URL, or by selecting a control or button in an external customer support application (not shown). Upon receiving the request, server 1 will query database 4 to obtain all session code identifiers presented to users (step 56). As is discussed below, the CSR web page will be adapted to show the session code identifiers displayed to users. Preferably, only session code identifiers associated with active session codes, or that were requested in the past few minutes, will be retrieved. This may be accomplished by storing a time code in database 4 with the session code identifier and user web page identifier (step 52), by requesting the active session codes from the web server, or by utilizing session code identifiers that incorporate a time code or other indication of the time at which the session code identifier was stored. In this way, server 1 may identify the list of likely active session code identifiers and may ignore any session code identifiers that are not recent.

Once server 1 has read the session code (step 58) from database 4, server 1 will adapt the CSR web page (step 60) to display the session code identifier and a replicate state link to CSR 3. While the layout and the design of the CSR web page is a matter of choice, and many alternative designs will be apparent to those of ordinary skill in the art, one preferable design would present a table to the CSR with each row showing a session code identifier and a button labeled “Get Session” to serve as the replicate state link. The CSR web page will thus display one or more session code identifiers and replicate state links, thereby enabling CSR 3 to select the replicate state link that corresponds to the session code identifier displayed to the user 2 with whom CSR 3 is communicating. The CSR web page may also conveniently include one or more phone scripts to provide the CSR with a predefined conversation thread to adopt when speaking to the user. Adapting web pages based on the contents of a database is well understood in the art and may preferably be accomplished with PHP, active server pages, or any number of other technologies that are well known and understood in the art. Once adapted, server 1 serves the CSR web page (step 62) to CSR 3.

Once the CSR web page has been served (step 62), CSR 3 can then scan the CSR web page for the session code identifier provided by user 2. Upon locating the session code identifier, CSR 3 can select the replicate state link (step 64) associated with that session code identifier. As part of adapting the CSR web page (step 60), server 1 will adapt the replicate state link such that, upon being selected, the user web page associated with the user web page identifier stored in database 4 and associated with the session code identifier, is requested from server 1. Preferably, the user web page identifier will simply be the URL to the user web page and the replicate state link will be a link to that URL. Upon selecting the replicate state link, server 1 will then serve to CSR 3 (step 68) the user web page that was viewed by the user when the user selected the session code link. In this manner, CSR 3 can see the same page that user 2 was viewing when user 2 chose to request assistance.

In the event user 2 navigates to a new user web page (steps 32, 34, 12, 30) while communicating with CSR 3, CSR 3 may resynchronize with user 2 by asking user 2 to select the session code link again (step 48). Upon doing so, the session code will again be stored in database 4 (step 52), but with the identifier to the current user web page. As will be well understood by those in the art, server 1 may either update the previously stored record, or insert a new record with a means of determining the order in which the records were stored, such as a timestamp or a sequence number. Server 1 may then retrieve only the last-stored user web page identifier (step 58) when adapting the CSR web page (step 60). CSR 3 may then request or refresh the CSR page (step 56) and then select the replicate state link (step 64) again, thereby causing server 1 to serve the current user web page (step 68) to CSR 3. Preferably, the session code identifier will not change until user 2 navigates to a page that is not part of the website and then later returns to the website. In that way, CSR 3 can resynchronize without asking user 2 for a new session code identifier. However, it is not necessary that the same session code be maintained and, as will be recognized by those of ordinary skill in the art, the present invention will operate effectively if server 1 generates a new session code (step 14) each time that a user requests a user web page (step 10).

The system, method, and medium of the present invention may also comprise a shopping cart. A shopping cart is a system that enables users of a website to select items for purchase and then maintains that list until the user is ready to complete the transaction. Because it is likely that multiple users will be accessing the website at any given time, the shopping cart is associated with a user. The association may be accomplished using a session code, a cookie, an identifier for the user, or by other means well understood in the art. Shopping carts are known in the art and may be implemented using client-side technologies, server-side technologies, or combinations thereof.

Where a shopping cart is utilized, at least one of the user web pages will comprise a purchase link (not shown). The purchase link is a link adapted to add a selected product to the shopping cart associated with a user. Adding a product to a shopping cart is preferably accomplished by storing a product identifier, typically a number or string of characters that uniquely identifies a given product or service, in the shopping cart.

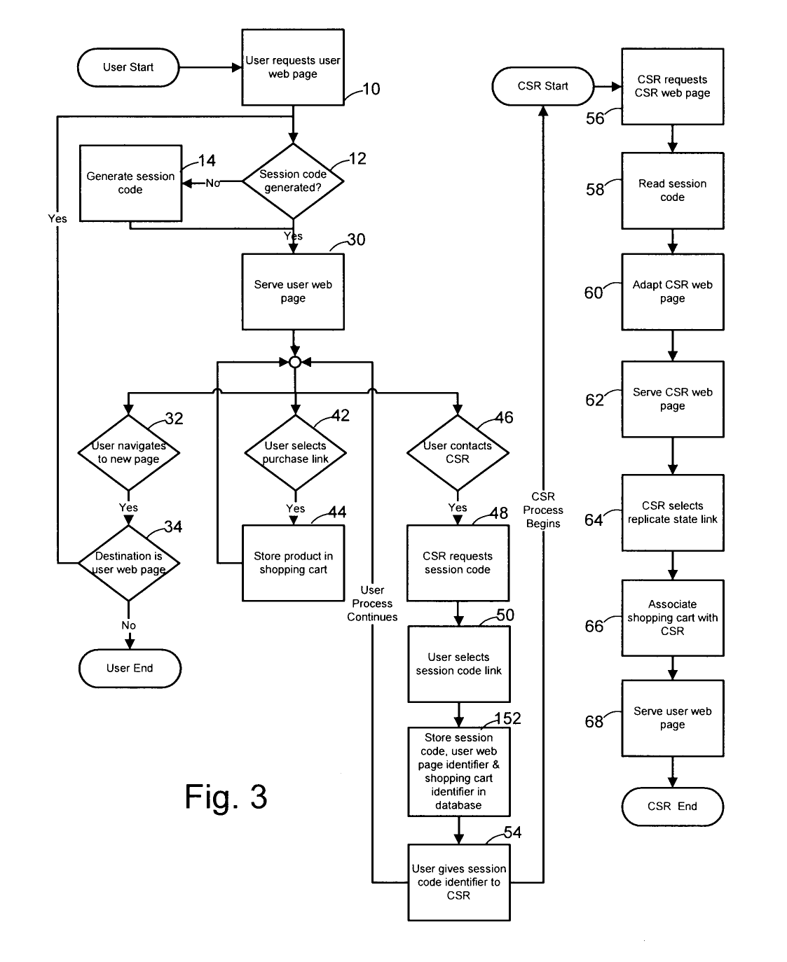

When a user 2 contacts a CSR 3 for assistance with a website that includes a shopping cart, it is desirable to enable the CSR 3 to view, and possibly manipulate, the items in the user's 2 shopping cart. In such an embodiment, and referring to FIG. 3, if user 2 selects a purchase link (step 42), the shopping cart will store the product in the shopping cart (step 44). This is typically accomplished by storing a product identifier on server 1 and/or in a cookie stored on the computer being used by user 2. Then, upon user 2 selecting the session code link (step 50), server 1 will store a shopping cart identifier in database 4 (step 152) in addition to the session code and user web page identifier. Storing an identifier to the shopping cart associated with user 2 in database 4 can enable server 1 to further associate the shopping cart with the CSR 3 (step 66) when CSR 3 selects the replicate state link (step 64) on the CSR page. This may require further adaptation of the replicate state link (step 60) according to the design of the shopping cart or the user web page showing the list of products in the cart or, in the event the shopping cart utilizes a cookie on the client machine, may be accomplished by storing a cookie on CSR's 3 computer in the same manner as the cookie is stored on user's 2 computer.

In one preferred embodiment of the present invention, the shopping carts are stored on server 1 and each shopping cart is assigned a unique identifier and is associated with a particular user 2 by storing a shopping cart identifier in a shopping cart identifier cookie that is served in conjunction with a user web page. In such embodiments, the user web pages further comprise a shopping cart page adapted to display the contents of the shopping cart and enable the user to manipulate those contents. This may be accomplished by further programming server 1 such that, upon receiving a request for the shopping cart page, server 1 adapts the shopping cart page by reading the shopping cart identifier from the shopping cart identifier cookie, reading one or more product identifiers from the shopping cart stored on server 1, and adapting the shopping cart page to display the list of products selected by user 2 for potential purchase. The use of cookies in connection with shopping carts stored on servers is well understood in the art.

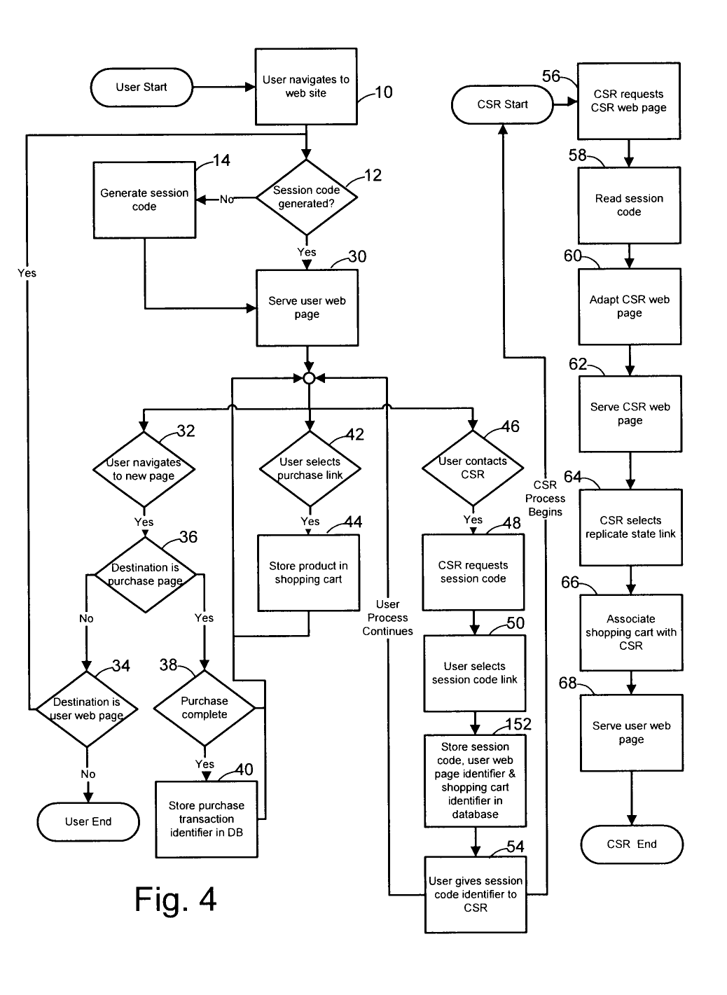

Further embodiments of the present invention enable the storage and analysis of data relating to website visits that culminate in a purchase transaction. In such embodiments, the user web pages further comprise a purchase page (not shown) adapted to enable the user to complete a purchase transaction. Such a purchase page may be a single page or a series of linked pages adapted to gather necessary sales and shipping information, as is well understood in the art. Referring to FIG. 4, server 1 may be further programmed such that upon receiving a request to serve a user web page to user 2, server 1 determines if that user web page is a purchase page (step 36) and if navigation to that page indicates a completed purchase transaction (step 38). In the event user 2 has contacted CSR 3 prior to making a purchase, server 1 stores a purchase transaction identifier in database 4 (step 40). Storing the purchase transaction identifier in database 4 (step 40) will preferably include also storing the session code, thereby enabling the purchase transaction to be associated with the support event. Those of ordinary skill in the art will readily understand that detecting whether a purchase is complete (step 38) need not always occur upon navigation to a new user web page and, instead, may be incorporated into the server-side logic utilized to complete a purchase transaction. Whether that logic is triggered as the result of the user requesting a new page or as a result of some other action, such as selecting a control, is a matter of choice.

Storing the purchase transaction identifier in database 4 in this manner allows a business operating such a website to generate reports relating to purchase transactions. In the event the session code is stored with or linked to the purchase transaction, the business can determine if the same session code was also stored as a result of a user 2 requesting assistance from CSR 3 (see steps 52, 152). In this way, the business may develop reports that enable it to gain a better understanding of the likelihood that a user will contact a CSR prior to making a purchase and the likelihood that a user will make a purchase after contacting a CSR. Assuming that additional information relating to the purchase transaction (for example the products purchased, cost of transaction, demographics of the purchaser, etc.) are also available, the business may develop reports that enable it to better understand the types of customers, products, and purchasing scenarios that are most likely to require CSR assistance prior to making a purchase. The business may then modify its website, help files, pricing, etc. to better serve its target customers. The process of developing reports and using the information contained therein to improve websites and customer satisfaction is known in the art.

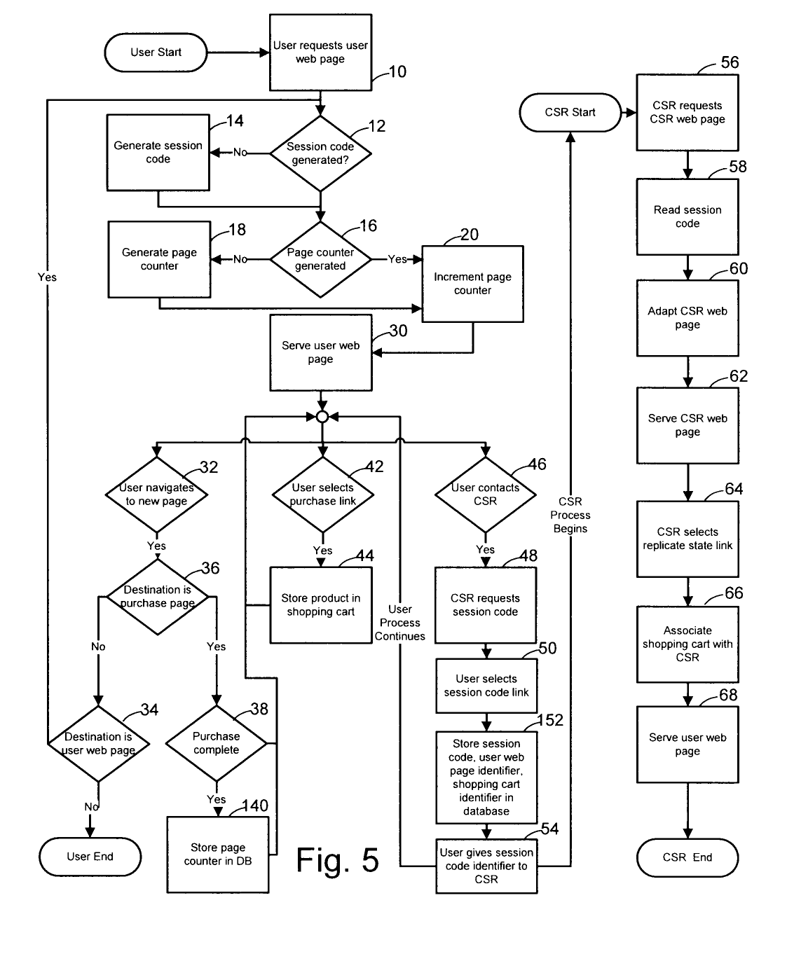

Linking a session code to a purchase transaction in database 4 can facilitate more advanced reporting as well. One such report would track the number of user web pages visited prior to completing a transaction by implementing a page counter for each session code. Referring to FIG. 5, this may be accomplished by further programming server 1 such that, upon determining that a session code has been generated (see steps 12, 14), server 1 determines if a page counter has been associated with such session (step 16) and, if not, generating one (step 18). Once a page counter is generated, it is incremented for each page visited in that session (step 20). The page counter may be stored in a session variable maintained by the web server, or in a file, or in database 4, all of which are well understood in the art. Then, upon determining that a purchase transaction has been completed, as is discussed above, server 1 may store the page counter in database 4 together with a purchase transaction identifier (step 140), thereby enabling the business to determine the number of pages visited prior to such purchase transaction. The page count may also be made available to CSR 3, thereby providing CSR 3 with additional information regarding the user's activity on the site prior to contacting CSR 3. This may be done as part of adapting the CSR web page (step 60) or by providing a link to CSR 3 enabling him or her to access such information on demand.

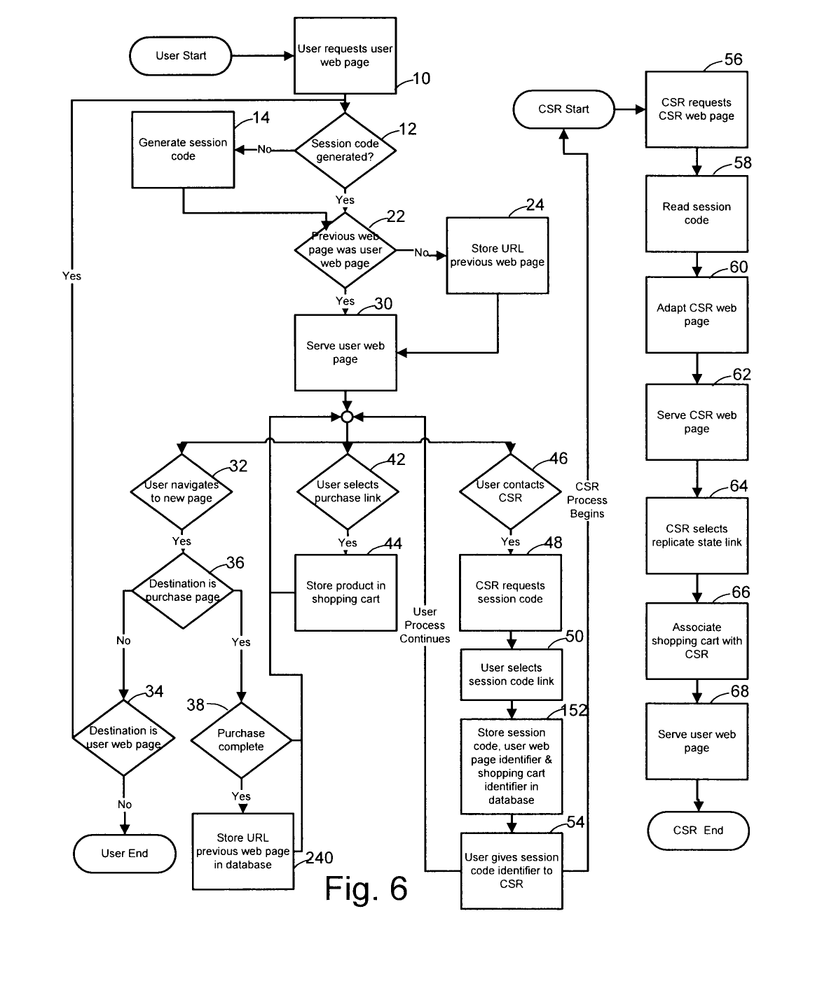

In a similar fashion, the business may track additional information regarding each purchase transaction including the page and site the user was visiting prior to navigating to the business's website (the referring page or site) or even the full history of pages navigated by the user prior to making a purchase or contacting a CSR. Referring to FIG. 6, tracking the referring page or site may be accomplished by further programming server 1 such that, upon determining if a session code has been generated for the user's 2 visit (see steps 12, 14), server 1 determines if the previous web page was one of the user web pages on the business's site (step 22). Identifying the URL to the previous referring web page is well understood in the art and is generally accomplished by interrogating an object or variable exposed by the web server. Upon obtaining the URL of the previous page, server 1 can analyze that URL to determine if it is for a user web page or a page on a different site. If it is for a page on a different site, server 1 may then store that URL in a manner that links it to the session code (step 24). This may be accomplished in any of the manners described above in connection with storing a page counter. Then, upon completion of purchase transaction, server 1 can store the URL to the previous web page in database 4 in a manner that links it to the purchase transaction (step 240). Having the URL stored in such a manner thereby enables the business to determine which referring websites generate which purchase transactions and provide valuable information relating to the effectiveness of advertising and co-marketing efforts. The referring URL may also be made available to CSR 3 in the same manner a page counter can be made available as is described above.

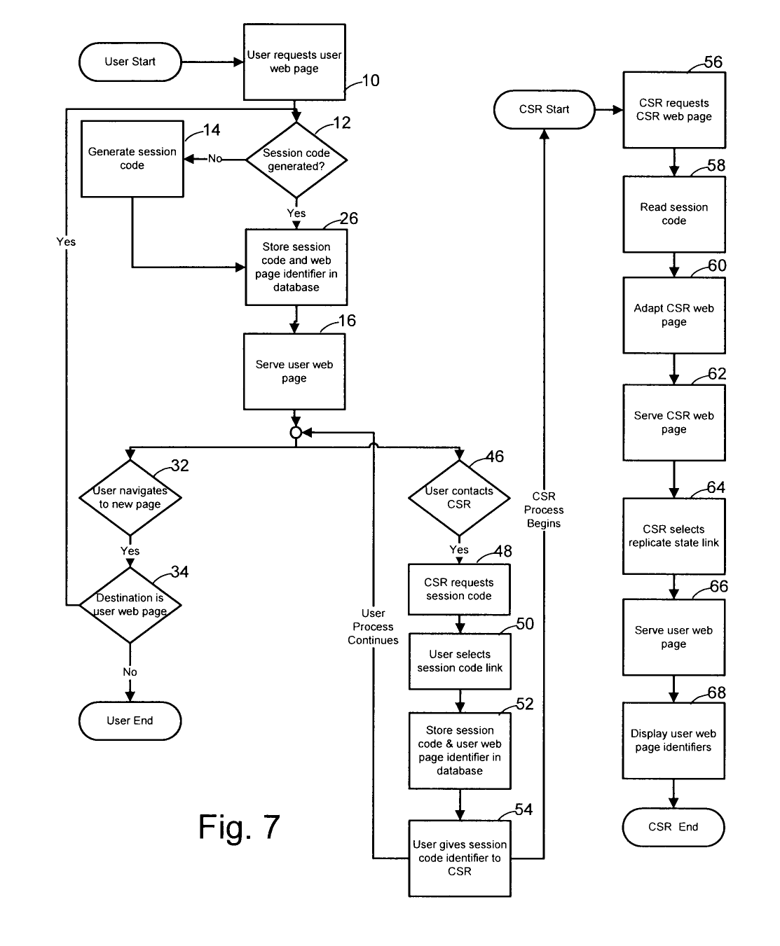

Similarly, the entire history of a user's navigation on the website may also be stored for further reporting or for use by the CSR during a support call. Referring to FIG. 7, server 1 may be further programmed to, upon receiving a request for a user web page (step 10) and determining if a session code has been generated (see steps 12, 14), store the session code and a web page identifier for the requested user web page in database 4 (step 16). Then, in the same manners described above that a page counter or referring URL may be made available to CSR 3, so can the history of the user's 2 navigation on the site (step 68). Preferably, this will be accomplished by providing a link to the site history on the CSR page or by further adapting the replicate state link to display the history in a pop up window upon adaptation of the CSR web page (step 60). As is well understood in the art, there are a number of mechanisms by which a link to the navigation history or the history itself may made available or displayed to CSR 3. Providing a link on the CSR web page is only one such mechanism. Once the history of the web page identifiers are stored in database 4 in a manner that associates them with a session code, the mechanism by which the history is made available to CSR 3 is a matter of choice. Having the history in database 4 and linked to the session code can also enable the business to generate reports regarding navigation prior to making a purchase by also storing a purchase transaction identifier associated with the session code, as is discussed above.

The support experience may be further enhanced by providing additional information about a user to CSR. As is well understood in the art, a request for a user web page includes a TCP/IP address that is assigned to user 2. Using the TCP/IP address, server 1 may determine information such as the approximate location of the user's computer (i.e. the city and state). Server 1 can then obtain additional information such as the weather conditions at that location. Server 1 can also obtain further information, such as the local date and time, from the user's 2 computer or from a third party service. Acquiring such information is well understood in the art and may be accomplished by server 1 itself, by server 1 receiving information from user's 2 computer, or by further programming server 1 to work with another web site, web service, or software package adapted to provide such information in a format that is convenient for server 1. Server 1 may then further adapt the CSR web page (step 60) to display the location, and other available information to CSR 3, thereby enabling CSR 3 to incorporate that information into a support script or simply use it as appropriate when communicating with user 2. As is well understood in the art, other information about the user's 2 computer (profile information) is also available to server 1 upon the user requesting a user web page. Such information typically includes the operating system (e.g. Windows XP, Linux, or Mac OS) and browser type (e.g. Internet Explorer or Firefox) being used by the user to navigate the site, the resolution of the screen, whether the browser is Java-enabled, whether to browser will accept cookies, and the type of connection user 2 has to the Internet. Further adapting the CSR web page (step 60) to display profile information to CSR 3 can further streamline the support experience and enable the CSR to diagnose a wider range of issues without requesting additional information from user 2. Storing such information in database 4 enables even further reporting regarding the locations and profiles of the users utilizing the site, requesting support from CSRs, and, when linked to purchases as is described above, making purchases on that site. The methods of storing and reporting on such information are the same as are described above for storing and reporting on website navigation history, page counts, and referring web pages. Other methods for accomplishing the same result are understood in the art.

The method of the present invention may be performed using the embodiments of the system described above and is also illustrated in FIGS. 1-7. Accordingly, the detailed description of the system of the present invention is illustrative of the method of the present invention and vice versa. The method enables a CSR to assist users navigating a website and comprises several steps. First, a database 4 must be provided. As is discussed above, database 4 may be any type of system storing records of information including flat file systems, object-oriented systems, or hierarchical systems, but is preferably a relational database such as MySQL or SQL Server running on a computer adapted to operate as a database server capable of responding to queries from web server software such as Internet Information Server or Apache.

A further step is to provide a website comprising a plurality of user web pages and a CSR web page. The plurality of user web pages and the CSR web page are substantially the same as those served by server 1 in the system of the present invention described above. The web pages may typically be served by web server software and may conveniently be adapted to present an e-commerce site enabling users 2 to purchase products over a public network such as the Internet, or may be adapted to present a website providing services over a private network such as a company intranet. Similar to the system of the present invention, while the method of the present invention is well suited to e-commerce applications, it is equally useful in any scenario in which website (public or private) users may need assistance operating, navigating, understanding, or otherwise using the website. Also similar to the system of the present invention, the CSR web page provided in the method is typically restricted to be available only to CSRs working for the provider of the website, but may be available over a public network as well. If the CSR web page is available over a public network, preferably a mechanism such as a password or code inserted into the URL of the CSR web page will be used to restrict access to the page to authorized persons and systems. Such mechanisms are well understood by those of ordinary skill in the art.

A further step of the method is performed upon a user 2 requesting one of the user web pages. Such a request will typically be received by a computer running web server software such as server 1. While the computer will preferably be a server such as a rack-mounted blade server, it may also be any device capable of serving a web page, including a portable device or a device using embedded software to present a user interface via web pages. Upon a user requesting one of the user web pages, it is determined if a session code has been generated for the user, and if a session code has not been generated for the user, a session code is generated. The session code may preferably be a session code generated by web server software such as is described above, or may be any value sufficient to identify user 2.

Further steps include providing a session code link on at least one of the user web pages and, upon the user selecting the session code link, displaying a session code identifier to the user 2 and storing the session code and a user web page identifier in the database 4. The session code link may conveniently be the link provided in the user web pages of the system of the present invention (described above) and can be any user interface method or technique responsive to an action of the user 2. For example purposes only, and without limitation, in the event the user views a user web page through a traditional web browser, the session code link may conveniently be a hyperlink or an image adapted to react to the user 2 clicking or otherwise selecting the image. As a further example, in the event the user views the web page on a portable device such as a cellular phone or media player, the link may be a button or other hardware control on the device, such as a help button, adapted to display a session code to the user upon request. In this specification, it is understood that displaying means communicating material to the user 2 through an appropriate mechanism. Traditionally, such communication would involve opening a web page, pop-up window, or dialog on a computer display or touch screen. However, it could also involve using a recorded or generated voice, sequence of sounds, tactile feedback, or any other mechanism of communicating information to the user as is appropriate for the device being used by the user 2 to access the user web pages. Storing the session code and user web page identifier is preferably accomplished substantially upon displaying the session code identifier and may be accomplished by programming a server in the same manner as is described above in connection with the system of the present invention.

A further step is performed upon a CSR 3 requesting the CSR web page and involves adapting the CSR web page to display the session code identifier and a replicate state link, and serving the adapted CSR web page to the CSR 3. As with the user web pages, the CSR web page may be served by web server software in the manner that is well understood in the art. Adapting the CSR web page will preferably be accomplished by programming a server such as server 1 to read the session code identifier from the database 4 and dynamically generating the replicate state link on the CSR web page. This may be accomplished as is described above for the system of the present invention or by any of a number of techniques for dynamically generating web pages that are well understood in the art. The replicate state link will preferably be a link on the CSR web page such as a button or similar control labeled with the session code identifier. Upon receiving the CSR web page, the CSR may scan the page for the replicate state link labeled with a given session code identifier.

A further step, performed subsequent to the CSR web page being served to the CSR 3, involves the CSR 3 selecting the replicate state link and the subsequent serving of the user web page identified by the user web page identifier associated with the replicate state link to the CSR 3.

Via this method, users may receive, and CSRs may provide, assistance as follows. Referring to FIG. 1, user 2 may come to a point in his or her use of the website at which he or she desires to obtain assistance from a CSR 3. User 2 may then contact CSR 3 via telephone, Internet chat, in person, or via any other suitable means. CSR 3 may then ask user 2 to obtain the session code identifier by selecting the session code link and provide it to CSR 3. Alternatively, in the event user 2 is familiar with the website from previous visits or the website provides an explanation of the support process, user 2 may select the session code link in preparation for contacting CSR 3. Regardless, upon receiving the session code identifier, CSR 3 may then view the user web page being viewed by user 2, thereby enabling for a more efficient support experience.

The method of the present invention may further comprise the steps of providing a shopping cart and a purchase link on at least one of the user web pages. Shopping carts are well known in the art and providing a shopping cart suitable for the present method may be accomplished by implementing an embodiment of the system of the present invention that uses a shopping cart (described above), or by implementing any of a variety of well known shopping cart systems, such as ShopSite. The purchase link of the present method is adapted such that, upon being selected by the user 2, an identifier for a product is stored in the shopping cart. In this specification, the term “product” includes, but is not limited to, both goods and services that may be selected and potentially purchased through the use of the user web pages. It may also include any other items that are not necessarily purchased, such as user accounts, previously purchased products or services, benefits provided to the user by or through the website provider and accessible or configurable through the user web pages and which may be selected and added to a storage mechanism (i.e. a shopping cart) for later action. The system of the present invention describes the provision and adaptation of a suitable purchase link and the use of such a link to store a product identifier in said shopping cart.

As is described above, where a shopping cart is provided to the user 2, it is desirable to also allow the CSR to access that shopping cart. Accordingly, upon the user 2 selecting the session code link, a shopping cart identifier may be stored. The shopping cart identifier may be any mechanism that distinguishes one user's shopping cart from that of another user. A suitable shopping cart identifier would be a session code assigned to the user 2 or a value associated with the session code. Then, upon the CSR 3 selecting the replicate state link, the shopping cart may be associated with the CSR 3, whereby the CSR 3 may view the shopping cart associated with the user 2 the CSR 3 is assisting. Associating the shopping cart with the CSR 3 may be accomplished as is described in the system of the present invention or in a variety of other ways that will be apparent to those of ordinary skill in the art including, without limitation, reading the shopping cart identifier, querying the shopping cart for its contents, and providing a CSR-specific user interface for viewing and manipulating the contents of the shopping cart.

A further step in a preferred embodiment of the method of the present invention involves further providing a purchase page adapted to enable the user 2 to complete a purchase transaction. Just as the term “product” is broadly used to include goods, services, and other items herein, the term “purchase transaction” is broadly used to include any action whereupon the user commits to a course of action relating to the contents of a shopping cart. For example, purchasing the items shown in the cart, cancelling services identified in the cart, or updating information relating to items in the cart in some other manner.

Where such a purchase page is provided, the method may comprise further steps enabling the website provider to link certain information to a completed purchase transaction. This may be accomplished by, upon a user 2 requesting a user web page, determining if the user's 2 previous web page was one of the user web pages on the website. As is well understood in the art, this may be accomplished by requesting the URL of the previous, or referring, web page from the web server software and parsing that URL to determine if it is a URL for one of the user web pages. If the URL is not for a user web page on the website, it may have been for a web page with an advertisement for the website or a search engine used to assist users in locating the website. If the previous web page was not one of the user web pages, the URL of the previous web page, which may be a standard URL or any other value suitable to identify the referring page or the provider of the referring page, may be stored on the server. Then, upon completing a purchase transaction the URL of the previous web page may be stored in the database 4. In this manner, the purchase transaction may be associated with the previous, or referring, web page so that reports and queries may be run later to determine which referral sources should be credited with which purchase transactions, or accessed by the CSR during a support call to assist the CSR in understanding how the user navigated to a given page.

Just as the CSR 3 may wish to access information relating to the referring page during a support call, the CSR may also wish to see the history of the user's navigation on the website. This may be accomplished with the following further steps. Upon the user requesting one of the user web pages, the session code and an identifier for the requested user web page may be stored. This may be suitably accomplished by providing the system of the present invention, and the identifier for the user web page may be the URL of that page. However, given that the history of navigation is not generally exposed to persons other than CSRs, it may also be an internal identifier such as a GUID or any unique value associated with the user web page. Once the web page identifiers are stored on the server, they may be displayed to the CSR whereby the CSR may perceive the history of the user's navigation on the website, in addition to the page on which the user selected the session code link. This may be accomplished by providing the system of the present invention or by other means well known in the art such as querying the history based on the session code, generating a text, thumbnail, or graphical view of the pages visited, and then displaying that history to the CSR, all through a web page interface or a custom application.

The method of the present invention may further comprise displaying a profile of the user to the CSR. As is described above, the profile may comprise the operating system and browser type utilized by the user. It is understood by those in the art that the operating system and/or browser may be displayed by their name, a version number, an icon, or by some other identifier. It is also understood that they may be displayed explicitly or by implication. For example, where a particular operating system enables only one browser or only one browser capable of accessing the particular website, then displaying the browser will, by implication, also display the operating system. Similarly, where a particular browser only operates on one type of machine or operating system, displaying that browser will, by implication, also display the operating system or machine. Obtaining the browser and operating system is well known in the art and may be accomplished by querying the web server software. As is described above, this may be accomplished by providing the system of the present invention or by other means well known in the art such as by providing the information to the CSR via a web page or via a custom application.

As is enabled by the system of the present invention, the CSR 3 may also wish to view the location of the user 2 and information relating to that location during the support event. Accordingly, the method of the present invention may further comprise displaying the location of the user 2 and information relating to that location such as the local time and weather to the CSR 3. As is described above, obtaining such information is well understood in the art and is generally accomplished by passing the IP address of the device being used by the user to a third party service and receiving additional information directly from the user's 2 computer. As is also described above, the information may then be displayed via a web page, or in a custom application made available to the CSR.

The present invention further comprises a computer-readable medium 5 having computer-readable instructions stored thereon for execution by a processor to perform a method comprising the steps described herein. Medium 5 may conveniently be a solid-state memory (or RAM) within a computer, a read-only solid-state memory (or ROM) such as a USB drive or embedded memory, a set of one or more CDs or DVDs, or a hard drive within a computer. The instructions on the medium will typically be a combination of compiled object code, web pages, and server-side script files, such as are typically read by web server software and utilized to generate dynamic web pages. Where appropriate, compiled object code may conveniently be used to provide shopping cart and reporting functionality discussed above. Additionally, in the event a relational database system is utilized, certain of the instructions may be in the form of dynamic or pre-processed database queries, stored procedures, or other instructions intended to be executed in conjunction with the relational database system. The processor will typically be a central processing unit, or CPU, on a server designed to host a website on a global, publicly-accessible network. However, given that a wide variety of computers and devices (including portable computers, portable data accessories, cellular phones, and devices with embedded software) are capable of hosting a website or web-based user interface, it is understood that the present invention is not restricted to hardware designed to host publicly accessible websites over the Internet. Accordingly, the medium of the present invention may be any computer-readable medium or device capable of holding instructions that can be read and executed by any processor in a device capable of hosting a web page. Additionally, as is well understood in the art, in applications where the server is a group of computers or devices adapted to work together, the medium may be similarly divided among those computers or devices. Finally, as is well understood in the art, the medium may conveniently be installed in the computer hosting a webpage, or in a computer or other device that is accessible to the hosting device over a network.

As defined above, within the context of the present invention, a CSR 3 need not be a human being. Instead, a CSR 3 may be an automated agent. In such an embodiment, the CSR web page may be a standard HTML page or any file readable by the CSR 3, including an XML file, flat file, or set of database records. In such embodiments, displaying information to the automated CSR 3 would be accomplished by making the file available to the automated CSR 3 or activating it through a programmatic mechanism such as a function call or method invocation made by the CSR 3. The automated CSR 3 would select links by requesting information identified in the link programmatically and would communicate with the user via an online chat interface or a simulated voice.

Finally, while the foregoing describes preferred embodiments of the system, method, and medium of the present invention, it is to be understood that this description is to be considered as illustrative of the principles of the invention and is not to be limitative thereof, as numerous other variations, all within the scope of the invention, will readily occur to others of ordinary skill in the art. Without limitation, such variations and choices include varying the order of the steps described above, incorporating the links and information described above on different web pages, utilizing different display mechanisms and server-client communication technologies such as AJAX, utilizing multiple browser windows or tabs, utilizing applications, applets, or controls to provide information to the CSR 3 or user 2 in addition to, or instead of, the CSR web page or user web pages, and utilizing different database and storage methods to retain the information discussed above as required.

I claim:

1. A system for tracking and replicating user navigation on a website comprising a plurality of user web pages, a CSR web page, a server and a database wherein
said server is programmed to serve said user web pages and said CSR web page;
said server is further programmed, upon a user requesting one of said user web pages, to determine if a session code has been generated for said user, and if said session code has not been generated for said user, to generate said session code for said user;
at least one of said user web pages comprise a session code link adapted such that, upon said user selecting said session code link,
said user web page displays a session code identifier to said user, and
said server stores said session code and a user web page identifier in said database;
said server is further programmed, upon a CSR requesting said CSR web page,
to read said session code from said database,
to adapt said CSR web page to display a said session code identifier and a replicate state link to said CSR, and
to serve said adapted CSR web page to said CSR; and
said replicate state link is adapted, upon said CSR selecting said replicate state link, to cause said server to serve said user web page identified by said user web page identifier to said CSR.

2. The system of claim 1 further comprising a shopping cart associated with said user wherein
at least one of said user web pages further comprises a purchase link, and
said server is programmed such that,
upon said user selecting said purchase link, said server stores a product identifier in said shopping cart,
upon said user selecting said session code link, said server stores a shopping cart identifier in said database, and
upon said CSR selecting said replicate state link, said server further associates said shopping cart with said CSR.

3. The system of claim 2 wherein
said shopping cart is stored on said server,
said server associates said shopping cart with said user by storing said shopping cart identifier in a shopping cart identifier cookie served to said user,
said server further associates said shopping cart with said CSR by storing said shopping cart identifier in a shopping cart identifier cookie served to said CSR,
said user web pages further comprise a shopping cart page,
said server is further programmed, upon serving said shopping cart page to said CSR,
to read said shopping cart identifier from said shopping cart identifier cookie served to said CSR,
to read said product identifier from said shopping cart identified by said shopping cart identifier,
to adapt said shopping cart page to display a product identified by said product identifier, and
to serve said adapted shopping cart page to said CSR,
whereby, said server will serve said adapted shopping cart page to said CSR.

4. The system of claim 2 further wherein
said user web pages further comprise a user purchase page
said user purchase page is adapted to enable said user to complete a purchase transaction, and
said server is further programmed, upon said user completing said purchase transaction, to store a purchase transaction identifier in said database.

5. The system of claim 4 wherein said server is further programmed,
upon a user requesting one of said user web pages,
to determine if a page counter has been generated for said user, and if said page counter has been generated for said user, to generate said page counter for said user, and
to increment said page counter; and
upon said user completing said purchase transaction, to store said page counter in said database.

6. The system of claim 4 wherein said server is further programmed,
upon a user requesting one of said user web pages,
to determine if said user's previous web page was one of said user web pages, and if said previous web page was not one of said user pages, to store the URL of said previous web page on said server; and
upon said user completing said purchase transaction, to store said URL of said previous web page in said database.

7. The system of claim 1 wherein said server is further programmed, upon a CSR requesting said CSR web page, to adapt said CSR web page to display the location of said user.

8. The system of claim 1 wherein said server is further programmed to adapt said CSR web page to display a profile of said user, said profile comprising the operating system and the browser type utilized by said user.

9. The system of claim 1 wherein said server is further programmed,
upon said user requesting one of said user web pages, to store said session code and said user web page identifier in said database; and
upon said CSR selecting said replicate state link, to display said user web page identifiers to said CSR;
whereby said CSR can see the history of said user's navigation on said website.

10. A method of enabling a customer service representative to assist users in navigating a website comprising the steps of:
providing a database, and
providing a website comprising a plurality of user web pages and a CSR web page,
upon a user requesting one of said user web pages, determining if a session code has been generated for said user, and if said session code has not been generated for said user, generating said session code for said user;
providing a session code link on at least one of said user web pages,
upon said user selecting said session code link, displaying a session code identifier to said user and storing said session code and a user web page identifier in said database;
upon a CSR requesting said CSR web page, adapting said CSR web page to display said session code identifier and a replicate state link to said CSR, and serving said adapted CSR web page to said CSR; and
upon said CSR selecting said replicate state link, serving said user web page identified by said user web page identifier to said CSR,
whereby said user may obtain said session code identifier, contact said CSR, and provide said session code identifier to said CSR, and said CSR can view said user web page being viewed by said user.

11. A method of enabling a customer service representative to assist users in navigating a website as in claim 10 further comprising the steps of
providing a shopping cart,
providing a purchase link on at least one of said user web pages, and
upon said user selecting said purchase link, storing a product identifier in said shopping cart,
upon said user selecting said session code link, storing a shopping cart identifier, and
upon said CSR selecting said replicate state link, associating said shopping cart with said CSR,
whereby said CSR may view said shopping cart associated with said user.

12. A method of enabling a customer service representative to assist users in navigating a website as in claim 10 wherein said user web pages further comprise a purchase page adapted to enable said user to complete a purchase transaction, and further comprising the steps of
upon said user requesting one of said user web pages, determining if said user's previous web page was one of said user web pages, and if said previous web page was not one of said user pages, storing the URL of said previous web page on said server; and
upon said user completing said purchase transaction, storing said URL of said previous web page in a database,
whereby said purchase transaction may be associated with said previous web page.

13. A method of enabling a customer service representative to assist users in navigating a website as in claim 10 further comprising the step of displaying a profile of said user to said CSR, said profile comprising the operating system and the browser type utilized by said user.

14. A method of enabling a customer service representative to assist users in navigating a website as in claim 10 further comprising the step of displaying the location of said user to said CSR.

15. A method of enabling a customer service representative to assist users in navigating a website as in claim 10 further comprising the steps of
upon said user requesting one of said user web pages, storing said session code and said user web page identifier; and
displaying said user web page identifiers to said CSR,
whereby said CSR can see the history of said user's navigation on said website.

16. A computer-usable medium having computer readable instructions stored thereon for execution by a processor to perform a method comprising the steps of:
providing a website comprising a plurality of user web pages and a CSR web page, at least one of said user web pages comprising a session code link adapted to display a session code identifier, and
upon receiving a request for one of said user web pages, determining if a session code has been generated for the user associated with said request, and if said session code has not been generated for said user, generating said session code for said user,
upon said user selecting said session code link, storing said session code, said session code identifier, and a web page identifier,
upon receiving a request for said CSR web page,
adapting said CSR web page to display said session code identifier and a replicate state link to said CSR, and
serving said adapted CSR web page to said CSR; and
upon said CSR selecting said replicate state link, serving said user web page identified by said user web page identifier to said CSR.

17. A computer-usable medium having computer readable instructions stored thereon for execution by a processor to perform a method as in claim 16, wherein at least one of said user web pages further comprises a purchase link, and said method further comprises the steps of
providing a purchase link on at least one of said user web pages and, upon said user selecting said purchase link, storing a product identifier in a shopping cart associated with said user, and
upon said CSR selecting said replicate state link, further associating said shopping cart with said CSR.

18. A computer-usable medium having computer readable instructions stored thereon for execution by a processor to perform a method as in claim 16 wherein said user web pages further comprise a purchase page adapted to enable said user to complete a purchase transaction, and said method further comprises the steps of,
upon said user requesting one of said user web pages, determining if said user's previous web page was one of said user web pages, and if said previous web page was not one of said user pages, storing the URL of said previous web page on said server; and
upon said user completing said purchase transaction, storing said URL of said previous web page,
whereby said purchase transaction may be associated with said previous web page.

19. A computer-usable medium having computer readable instructions stored thereon for execution by a processor to perform a method as in claim 16 wherein said method further comprises the step of displaying a profile of said user to said CSR, said profile comprising the operating system and the browser type utilized by said user.

20. A computer-usable medium having computer readable instructions stored thereon for execution by a processor to perform a method as in claim 16 wherein said method further comprises the steps of,
upon said user requesting one of said user web pages, storing said session code and said user web page identifier in said database; and
displaying said user web page identifiers to said CSR,
whereby said CSR can see the history of said user's navigation on said website.
